(19) United States
(12) Patent Application Publication
(10) Pub. No.: US 2009/0090239 A1
(43) Pub. Date: Apr. 9, 2009

(54) FLUID ACTUATOR

(75) Inventor: Giovanni Trevisan, Cusago (IT)

Correspondence Address: INTELLECTUAL PROPERTY GROUP;FREDRIKSON & BYRON, P.A., 200 SOUTH SIXTH STREET, SUITE 4000, MINNEAPOLIS, MN, 55402, US

(73) Assignee: G.T. ATTUATORI SRL, Cusago (IT)

(21) Appl. No.: 12/282,555

(22) PCT Filed: Feb. 23, 2007
(86) PCT No.: PCT/EP2007/051761

§ 371 Date: Sep. 11, 2008

(30) Foreign Application Priority Data
Mar. 16, 2006 (IT) MI2006 A 000479

(51) Int. Cl. F15B 15/28; F15B 15/14; F15B 15/20; F15B 15/26

(52) U.S. Cl. 92/5 R; 92/165 R; 92/165 PR

(57) ABSTRACT

A fluid actuator for mechanical components in general comprises at least one piston (1, 3, 31, 32) which slides inside a cylindrical chamber (100) and which, during manual operation, moves integrally with a threaded rod (9) moved between two end-of-travel positions, by means of rotation of a screw nut (10). Indicator means indicate the displacement of the threaded rod (9) between the two end-of-travel positions.

The invention relates in particular to a fluid actuator for mechanical components in general, with an auxiliary manual operating system.

As is well-known, a fluid actuator is an operating device which converts the energy supplied by a fluid such as air, oil or the like into an actuating movement for mechanical components. For this purpose actuators for the operation of ball or butterfly valves, or for any application which requires actuation of an obturator member, are known.

The actuators mentioned above usually envisage a manual operating system to be used in those cases where the operating fluid is, for any reason, not available: the manual operating system generally consists of a handwheel which causes rotation of a threaded rod which pushes the pistons which, under normal conditions, are moved by the fluid.

In the known manual operating methods, however, there is no possibility of controlling the degree of opening/closing of the valves. Thus it is not possible to know with precision when to terminate rotation of the handwheel during opening/closing, with the risk of forcing it too much and causing damage to the actuator or the mechanical component operated by it.

The object of the present invention is to provide a fluid actuator with manual operating system able to provide an indication as to the degree of closing of the valve so as to overcome the drawbacks of the prior art.

The abovementioned object is achieved by a fluid actuator for mechanical components in general, comprising:
a cylindrical chamber inside which at least one piston is movable following the introduction of fluid inside the chamber;
a threaded rod which is integrally joined to said at least one piston so as to move together with it;
means for manual operation of the actuator in the event of an absence of the fluid supply to the chamber;

characterized in that it comprises:
a screw nut screwed onto the threaded rod, which threaded rod moves between two start and end of travel positions following operation of said manual operating means which rotate the screw nut relative to the direction of displacement of the threaded rod.

The characteristic features and advantages of the invention will emerge from the description, provided hereinbelow, of an example of embodiment thereof provided by way of a non-limiting example with reference to the accompanying drawings.

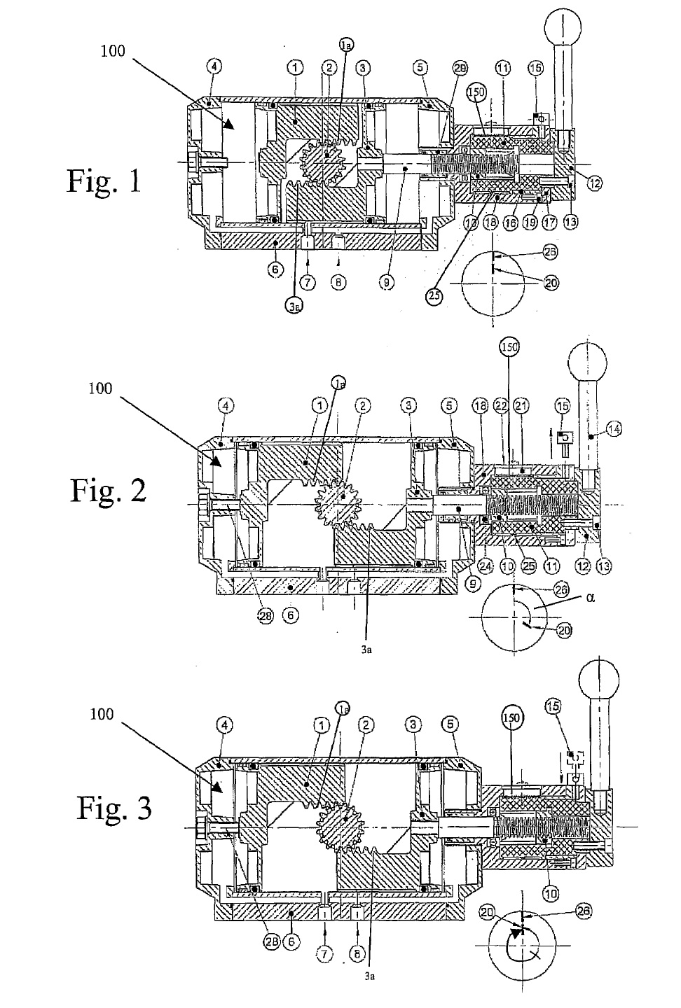

FIGS. 1, 2 and 3 show cross-sectional views of a fluid actuator with manual operating system, illustrating in sequence the respective conditions of fluid operation with the valve closed, manual operation for opening the valve and renewed fluid operation with the valve open.

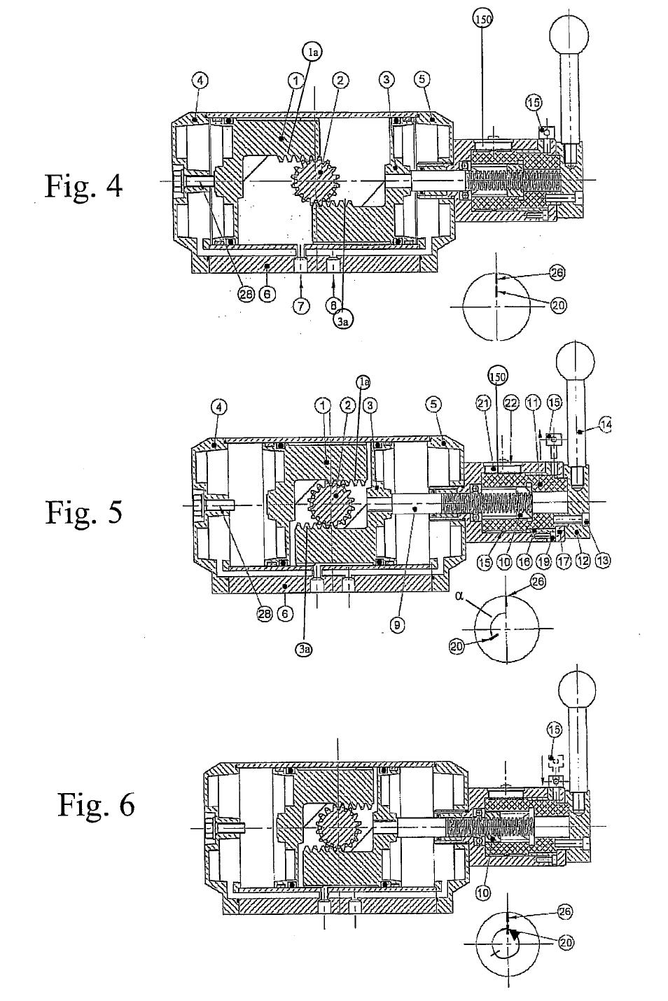

FIGS. 4, 5 and 6 shows cross-sectional views of a fluid actuator with manual operating system, illustrating in sequence the respective conditions of fluid operation with the valve open, manual operation for closing the valve and renewed fluid operation with the valve closed.

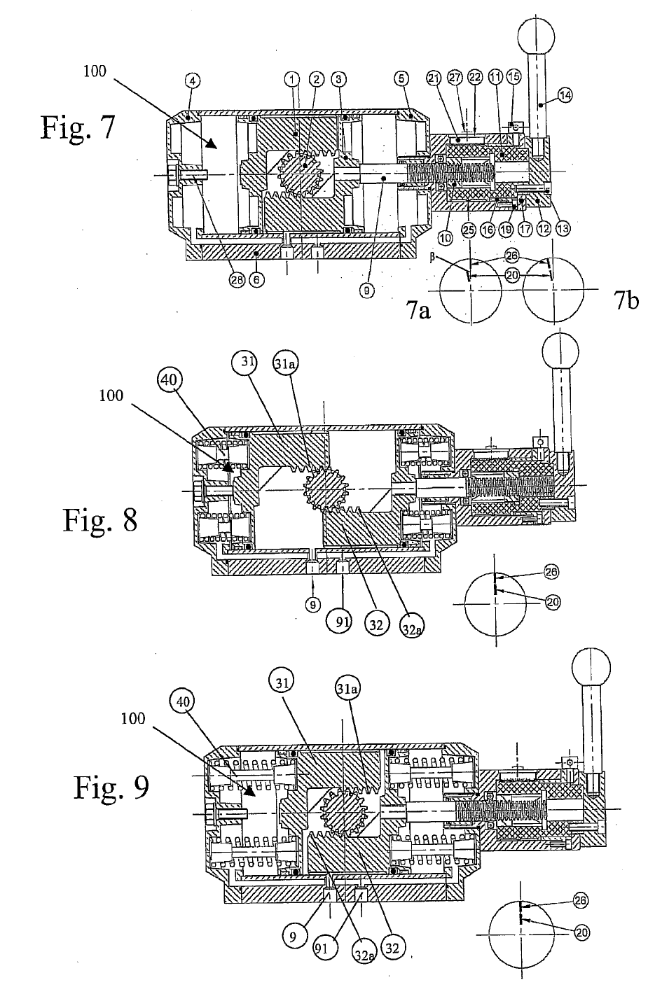

FIG. 7 shows a cross-sectional view of a fluid actuator with manual operating system, with indication of the variation in the degree of opening/closing of the valve performed.

FIGS. 8 and 9 show a cross-sectional view of a second embodiment of the actuator with manual operating system in the respective conditions where the valve is closed and open.

FIGS. 1-6 show schematically a fluid actuator in a preferred embodiment according to the present invention. In the figures mentioned, the various components are indicated by the same reference numbers.

The actuator comprises a cylindrical chamber 100 defined inside a hollow body 6 and closed by two end sections 4 and 5 inside which a pair of oppositely arranged pistons 1, 3, provided with respective racks 1a, 3a, are slidable: a pinion 2 is arranged between the latter and meshes with them. The pinion 2 is integral with a valve known per se and not shown in the drawings.

Two ducts 7, 8 for supplying fluid to the chamber allow the alternating introduction of a fluid flow, in particular an air flow, into the zone between the two pistons where the pinion 2 is situated or outside of them between the abovementioned pistons and the corresponding end sections 4,5.

The introduction of fluid via one of the two supply ducts 7, 8 allows the movement of the pistons 1, 3 inside the cylindrical chamber; in particular, when the air passes inside the duct 8, the pistons move towards the centre of the chamber and, when the air passes inside the duct 7, the pistons move towards the corresponding end sections 4, 5.

A threaded rod 9 is fixed to the piston 3 and, in the preferred embodiment of the invention, moves in alignment with it inside the chamber.

Advantageously, according to the invention, a screw nut 10 is screwed onto the threaded rod 9; a first sleeve 11, which is guided by a bush 16, seats the screw nut 10 and is fixed to a hub 12 by means of screws 13. A second sleeve 18 situated on the outside with respect to the first sleeve 11 and coaxial therewith is rigidly connected to the bush 16 by means of screws 19. Manual operating rods 14, which are fixed to the hub 12 in alignment with the pistons 1, 3, produce the rotation, in the event of manual operation of the actuator; the rotation of the hub 12, and the consequent rotation of the first sleeve 11 and the screw nut 10, cause the displacement of the threaded rod 9 between two end-of-travel positions and displacement of the pistons 1, 3.

Advantageously, according to the invention, the sleeve 11 has a first set of teeth 25 on its outermost surface. A movable disk 21 is positioned in the outer second sleeve 18 and has a second set of teeth 150 which mesh with the first set of teeth 25 of the first sleeve 11, during rotation of the sleeve 11 integrally with the screw nut 10.

The movable disk 21 has two indices, i.e. a fixed index 26 and a movable index 20; the movable index 20 indicates the displacement of the threaded rod 9 between two start and end of travel positions, relative to the fixed index 26. The index 20 also indicates the degree of displacement of the pistons 1,3 inside the chamber and therefore the degree of opening/closing of the valve, following rotation of the pinion 2 which meshes with the racks 1a and 3a.

A glass port 22 situated on the movable disk 21 allows viewing of the two indices 26 and 20.

A friction disk 17 is locked in position by means of screws 13 between the sleeve 11 and the hub 12. Advantageously, according to the invention, a seat for an anti-rotation locking pin 15 is present between the guide bush 16 of the sleeve 11 and the friction disk 17; the extraction of the anti-rotation locking pin 15 from the abovementioned seat allows the manually operated rods 14 to be operated so that rotation thereof is transmitted to the threaded rod 9 during a manual operating condition of the actuator. The anti-rotation locking pin 15 is fastened to the actuator, for example, by means of a chain.

The actuator described above, during normal fluid operation, causes opening or closing of a valve when the pistons 1, 3 move away from each other or towards each other following the introduction of compressed air through the supply ducts 7, 8. The pinion 2, meshing with the racks 1a, 3a of the two pistons 1, 3, moves in a clockwise or anti-clockwise direction, following the movement of the two pistons, determining opening/closing of the valve.

An actuator in the closed valve condition, where it is possible to note the two pistons 1, 3 in a position close to each other, is shown in FIG. 1; as can be seen from the alignment of the movable index 20 with the fixed index 26, the actuator is in the normal operating—i.e. fluid operating—condition.

An actuator in the open valve condition is shown in FIG. 4 where it is possible to see the two pistons separated from each other and stationary next to the end sections 4,5: as can be seen from the alignment of the movable index 20 with the fixed index 26, the actuator is in the normal operating condition, i.e. fluid operating condition.

During normal operation of the actuator by means of a fluid under pressure, the screw nut 10, which is screwed onto the threaded rod 9, moves longitudinally, without rotating, inside the inner sleeve 11 along a track which reproduces its external profile; the screw nut 10 does not prevent in any way the axial movement of the pistons 1, 3 which are able to rotate the pinion 2 freely, but at the same time is prevented from rotating about itself since its profile coincides practically with the cross-section of the track along which it travels.

Advantageously according to the invention, operation of the actuator, typical of normal operation, i.e. fluid operation, must be performed with the anti-rotation locking pin 15 inserted between the guide bush 16 of the sleeve 11 and the friction disk 17. In this way it is ensured that the screw nut 10 is unable to rotate on the threaded screw 9, namely manual operation of the actuator is prevented.

With reference now to the initial fluid operating condition with the valve closed, shown in FIG. 1, the steps of opening the valve by manual operation, as shown in FIG. 2, and for restoring fluid operation with the valve open, as shown in FIG. 3, will be described.

In the case where the fluid supplying the actuator is not available, because of an interruption in operation of the supply system or the like, the actuator may be operated manually.

Manual operation is subject to extraction of the pin 15, as shown in FIG. 2: this extraction allows simultaneous and synchronised rotation of the hub unit 12, first sleeve 11 and screw nut 10.

After removing the locking pin 15, the manual operating rods 14 are suitably rotated, in this case in an anti-clockwise direction, causing a corresponding rotation of the hub 12, the first sleeve 11 and the screw nut 10 which is retained in the track within the sleeve 11. The rotation of the screw nut 10 in an anti-clockwise direction causes the displacement of the threaded rod 9 in a direction coinciding with (or parallel to) the axis of the piston 3 towards an end-of-travel position in the vicinity of the manual operating rods 14. The manual operating rods 14, rotating, do not move along the threaded rod 9, being neither directly connected thereto, nor screwed thereon; they may be replaced by other suitable rotation means such as, for example, a handwheel, but without departing from the subject-matter of the invention.

The abovementioned rotation of the screw nut 10 has, during manual operation of the actuator, the same effect as introduction of fluid via the supply ducts 7 and 8, associated with fluid operation. The displacement of the threaded screw 9 draws the piston 3 in the same direction and causes a rotation of the pinion 2 in an anti-clockwise direction, also in the absence of supply fluid for the actuator.

An axial ball bearing 24 eliminates the rubbing friction between the screw nut 10 and the outer sleeve 18, which is present when the actuator functions with manual operation.

Each manual manoeuvre produces a corresponding rotation of the index 20 together with the movable disk 21.

In fact, during manual opening of the valve, the teeth 25 of the sleeve 11, following the rotation of the screw nut 10 which rotates integrally with the manual operating rods 14, mesh with the teeth 150 situated at the bottom of the movable disk 21, producing a rotation of the index 20, in a clockwise direction and through an angle “a”, with respect to the fixed index 26. The difference equal to an angle “a” other than zero between the two indices indicates that a manual manoeuvre has been performed, in this case a closing manoeuvre.

Where there is no longer need for manual operation, as shown in FIG. 2, the position of the screw nut 10 is such as not to allow any further movement of the piston 1, 3. Therefore, when the fluid has been restored or the external apparatus for introducing the fluid has been repaired, the screw nut 10 must be brought into a position such as to allow resumption of fluid operation; this position of the screw nut 10 is called the neutral position. The screw nut 10 assumes this position as a result of a further rotation of the manual operating rods 14, which causes rotational displacement of the screw nut 10 on the threaded rod 9, the latter remaining, on the contrary, stationary since it has already reached the end of its travel; as the screw nut 10 moves, the movable index 20 rotates further until it is aligned again with the fixed index 26, completing a rotation through 360° on the movable disk 21; this situation is shown in FIG. 3.

FIGS. 3 and 4 show apparently the same operating condition with the valve open: in reality, in FIG. 3 the condition is reached following manual operation of the actuator and subsequent restoration of the fluid operating condition (which can be deduced from the particular position of the movable index 20 which is aligned again with the fixed index 26). FIG. 4, however, shows an initial fluid operating condition which can be deduced from an initial aligned state of the fixed and movable indices.

In FIG. 1, reference was made to the initial fluid operating condition, with the valve closed; in FIGS. 4, 5 and 6, reference is made to the dual conditions compared to FIGS. 1, 2 and 3; there will therefore be a starting condition where the valve is open, the manual operating rods will be rotated in the clockwise direction, the threaded screw 9 will be displaced away from the abovementioned rods 14 and displacement of the movable index 20 will occur in the anti-clockwise direction relative to the fixed index 26.

Constructional variants of the actuator according to the invention are possible. A first variant envisages a single piston with rack which meshes with the pinion 2.

In a second variant the threaded rod 9 may not be in alignment with the piston 3.

In a further variant it is envisaged using a piston without rack and without pinion in order to cause a simple translatory movement, suitable for operation of a valve which has an actuator which can be actuated in a linear manner (and not by means of a rotation).

In an alternative embodiment of the present invention, shown in FIGS. 8 and 9, the actuator described above may be replaced by another actuator provided with single-acting pistons 31, 32 and return springs 40: all the other components are numbered as in FIGS. 1 to 6. In this case, while during fluid operation, the movement of the two pistons away from each other occurs with introduction of fluid via the supply duct 9, the movement towards each other may occur, not only by means of the supply duct 91, but also owing to the simple resilient effect of the springs 40 which relax following the compression during the relative movement of the two pistons away from each other.

According to the present invention, the degree of closing of the valve (neutral position of the screw nut) may also be adjusted.

The adjustment is performed in the following manner: after it has been determined that the anti-rotation locking pin 15 has been correctly inserted between the friction disk 17 and the guide bush 16, the screws 13, which lock the friction disk 17 between the hub 12 and the inner sleeve 11, are slackened slightly so as to allow the hub 12 to rotate freely with respect to the friction disk 17, which will remain locked in position by the anti-rotation locking pin 15.

The hub 12 is rotated by means of the manual operating rods 14 until the desired degree of closing of the valve is obtained, with consequent rotation of the movable index 20.

Now, the fixed index 26 indicates a neutral position of the screw nut 10 which is incorrect, because it is offset by an angle β relative to the real position.

A screw 27 which fixes the glass 22 is slackened and the latter is rotated until the fixed index 26 is aligned with the new position of the movable index 20. The screw 27 is tightened so as to fix the glass 22 in the new position. Now the screw nut is in the final neutral position.

The variation in the degree of closing of the valve, coinciding with the variation in the neutral position of the screw nut 10, can be seen in FIG. 7b where the alignment between the fixed index 26 and the movable index 20 is reached in a position which is offset by an angle β relative to the previous fixed position of the index 26.

The neutral position thus obtained is the position with which the movable index 20 must always be realigned after each manual manoeuvre, before being able to resume normal operation of the actuator by means of a fluid under pressure.

1. Fluid actuator for mechanical components in general, comprising:
a cylindrical chamber inside which at least one piston is movable between two end-of-travel positions following the introduction of fluid inside the chamber;
a threaded rod which is integrally joined to said at least one piston so as to move together with it;
means for manual operation of the actuator in the event of an absence in the fluid supply to the chamber;
a screw nut screwed onto the threaded rod, which screw nut is rotated by said manual operating means so as to displace the threaded rod between two end-of-travel positions corresponding to those of the piston in the cylindrical chamber.

2. Fluid actuator according to claim 1, comprising a first sleeve which is coaxial with the threaded rod and which surrounds said screw nut which is able to move inside it in the longitudinal direction rotating integrally with said sleeve.

3. Fluid actuator according to claims 2, in which the first sleeve is provided with a set of outer teeth and in which the indicator means comprises a movable disk position on a second sleeve situated on the outside with respect to the first sleeve and coaxial therewith and having a set of teeth which mesh with the teeth present on the first sleeve so as to be rotated by the latter.

4. Fluid actuator according to claim 3, in which said movable Disk is provided thereon with a mark which indicates the degree of displacement of the Threaded rod in accordance with the rotation of the disk.

5. Fluid actuator according to claim 1, in which the threaded rod is fixed to said at least one piston coxially therewith.

6. Fluid actuator according to claim 1, in which the fluid is introduced into the cylindrical chamber by means of at least one supply duct.

7. Fluid actuator according to claim 1, fluid operation of which is of the pneumatic or hydraulic type.

8. Fluid actuator according to claim 1, in which said at least one piston has a rack, on the opposite side to the threaded rod and arranged parallel to the direction of travel of the piston inside the chamber, which meshes with a pinion also contained in siad chamber, so as to produce the rotational actuating movement of the mechanical component operated by the actuator.

9. Fluid actuator according to claim comprising a second piston, opposite to the first piston, which has, on the opposite side of the threaded rod, a rack arranged parallel to the direction of travel of the piston inside the chamber and meshing with said pinion.

10. Fluid actuator according to claim 1, in which the mechanical component operated is a valve.

11. Fluid actuator according to claim 1, in which said at least one piston causes a simple translatory movement of a mechanical component which is operated.

12. Fluid actuator according to claim 9, in which the cylindrical chamber has, at its ends, two end sections and in which springs are present between the pistons and said end sections, said springs being compressed by the pistons during a movement away from each other so as to push the latter upon relaxation.

13. Fluid actuator according to claim 1, in which said manual operating means comprises rods.

14. Fluid actuator according to claim 1, in which said manual operating means comprise a handwheel.

15. Fluid actuator according to claim 13, comprising a friction disk between the first sleeve and said manual operating means.

16. Fluid actuator according to claim 14, comprising an anti-rotation Locking pin which locks rotation of the first sleeve during fluid operation of the Actuator.
